(19) United States
(12) Patent Application Publication
(10) Pub. No.: US 2013/0222643 A1
(43) Pub. Date: Aug. 29, 2013

(54) Image Capture Method and image Capture system thereof

(71) Applicant: HTC Corporation, (US)

(72) Inventors: Wan-Ju Tseng, Taoyuan County (TW); Yu-Chun Peng, Taoyuan County (TW); Hsien-Hsun Liu, Taoyuan County (TW); Ming-Kai Hsieh, Taoyuan County (TW); Fu-Chang Tseng, Taoyuan County (TW); Jing-Lung Wu, Taoyuan County (TW); Hsin-Ti Chueh, Taoyuan County (TW)

(73) Assignee: HTC CORPORATION, Taoyuan County (TW)

(21) Appl. No.: 13/773,604

(22) Filed: Feb. 21, 2013

Related U.S. Application Data
(60) Provisional application No. 61/602,617, filed on Feb. 24, 2012.

(51) Int. Cl. H04N 5/235

(52) U.S. Cl. CPC H04N 5/2354
USPC 348/234

(57) ABSTRACT

By adjusting focal distance of a lens unit of an image capture system and/or adjusting a luminance of a flashlight generator of the image capture system according to the focal distance, better luminance performance is fulfilled on an image captured by the image capture system.

### CROSS REFERENCE TO RELATED APPLICATIONS

This non-provisional application claims priority of U.S. Provisional Application No. 61/602,617 filed on Feb. 24, 2012.

### BACKGROUND OF THE INVENTION

1. Field of the Invention

The present invention relates to an image capture method and an image capture system thereof, and more particularly, an image capture method of using adjusted flashlight intensity corresponding to an applied focal distance and an image capture system utilizing the image capture method.

2. Description of the Prior Art

In a conventional image capture device, a flashlight generator is switched on or off in response to a manual setting or automatically by detecting surrounding brightness condition. And flashlight intensity for used to capture an image is determined automatically or by predefined setting. Conventionally, the flash light intensity is set with a few predetermined levels corresponding to a few predefined brightness conditions. An image may be captured with predetermined flashlight intensity for determining the level of actual flashlight intensity should be used prior to an actual image is captured. The predetermined flashlight intensity is usually weaker than the actual flashlight intensity, and is used for classifying which brightness condition the scene is taking is and thus determining which level of flashlight intensity should be used. However, an object or person desired to be captured on a digital image may not have satisfying image quality with merely the abovementioned settings because there may be imprecise perception about the desired person/object or the surrounding brightness (particularly in extreme light condition). The predefined levels of flashlight intensity may not be able to cover all brightness conditions of various surroundings. In addition, there maybe misjudges of the brightness conditions when the scene is taken is extreme surrounding. Therefore, there exists a need to provide an improved flashlight control method suitable for use in various brightness conditions.

### SUMMARY OF THE INVENTION

The claimed invention discloses an image capture method. The image capture method comprises capturing a first image; analyzing the first image to determine a focal distance corresponding to the first image; determining a flashlight intensity according to the focal distance; and capturing a second image according to the flashlight intensity.

The claimed invention discloses another image capture method for use in an image capture system comprising a lens unit and a flashlight generator for capturing images. The image capture method comprises receiving a plurality of preview images constantly; determining focus information corresponding to the plurality of preview images; adjusting a focus position of the lens module according to the focus information dynamically; receiving an input for capturing an image; determining the focus position of the lens module according to the focus information of a preview image received upon receiving the input; determining a flash intensity of the flash generator according to the focus information; and capturing the image according to the focus position and the flash intensity.

The claimed invention further discloses an image capture system. The image capture system comprises an image sensor module comprising a lens unit and a flash generator and configured to capture at least a first image and a second image; an image analyzer, configured to receive the first image from the image sensor module and analyze the first image to obtain focus information corresponding to the first image; and a flash intensity determination module, configured to determine a flash intensity of the flash generator according to the focus information; wherein the second image is captured according to the flash intensity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an image capture system according to one embodiment of the present invention.

FIGS. 2-3 illustrate the image capture method utilized by the image capture system shown in FIG. 1 according to embodiments of the present invention.

### DETAILED DESCRIPTION

For determining the flashlight intensity utilized for capturing an image to be satisfying for a user who observes the captured digital image, the present invention discloses an image capture method and an image capture system utilizing the image capture method.

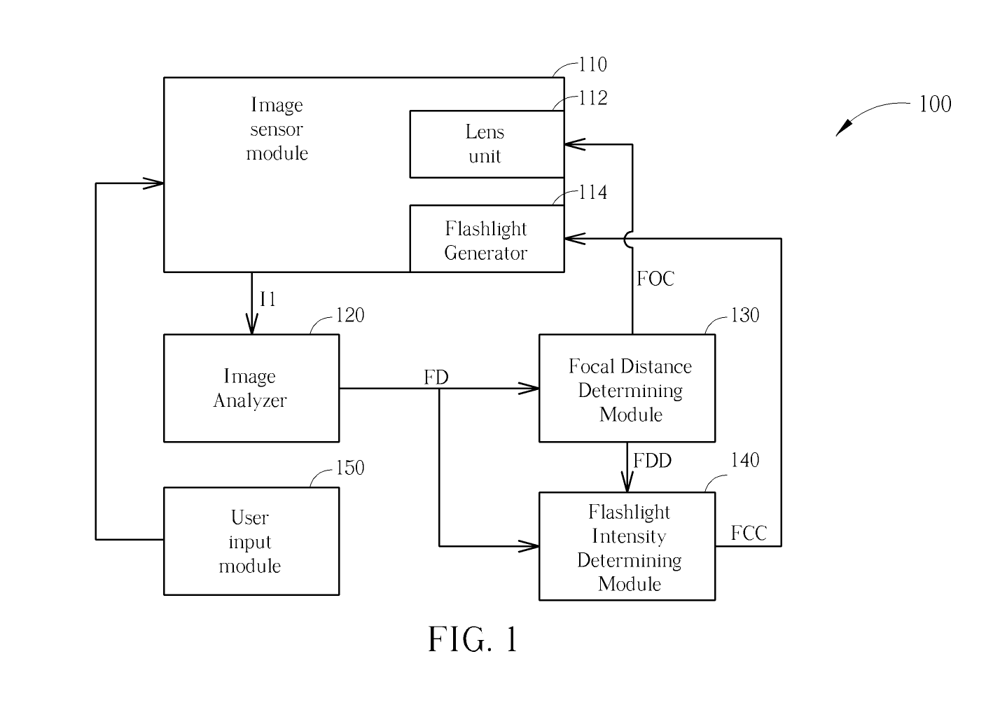

Please refer to FIG. 1, which illustrates an image capture system 100 according to one embodiment of the present invention. As shown in FIG. 1, the image capture system 100 includes an image sensor module 110, an image analyzer 120, a focal distance determination module 130, a flashlight determination module 140, and a user input module 150.

The image sensor module 110 comprises a lens unit 112 and a flashlight generator 114, among others. The image sensor module 110 is configured to capture an image according to a focal distance of the lens unit 112 and/or a flash intensity applied to the flashlight generator 114. In one embodiment of the present invention, the lens unit 112 is an extend depth of field (EDOF) lens that is capable of maintaining focus on objects within a comparatively wide range of focal distance than common lens unit without adjusting its position.

The image analyzer 120 is configured to analyze the image captured by the image sensor module 110 to determine a focal distance and/or a focus state corresponding to the image. The focus state may correspond to different ranges of focal distances. For example, in one embodiment of the invention, a first focus state may correspond to focal distance within a first range, and a second focus state may correspond to focal distance within a second range, and so on. In one embodiment of the present invention, the image analyzer 120 may be implemented as a dedicated processing unit and is configured to analyze the image in RAW image domain. In another embodiment of the present invention, the image analyzer may be implemented and integrated with an image signal processor comprising the focal distance determination module 130 and the flashlight intensity determination module 140. The image signal processor may perform various processing operations on the digital image, such as format conversion. The digital image maybe converted from RAW image format to RGB image format prior to being processed by the focal distance determination module 130 and the flashlight intensity determination module 140.

The focus determination module 130 is configured to determine whether the focal distance and/or focus state determined by the image analyzer 120 is within a threshold focus range and is configured to generate a focus control signal (FOC) according to the determination result. For example, the focus determination module 130 generates the focus control signal instructing the lens unit 112 to move a predetermined number of steps in a first direction in response to the focus distance being within a first threshold focus range or the focus state corresponds to the first threshold focus range. Upon receiving the focus control signal, the image sensor module 110 may be further configured to adjust the lens unit 112 by moving a position and/or a rotation angle instructed by the focus control signal. In another embodiment of the invention, in response to the focal distance and/or focus state is outside of the focus range of system limit, the focus control signal may instruct the lens unit 112 to move step by step or by angle, for example performing a full range scanning of the lens unit 112. Note that the threshold focus range may be predetermined according to experimental results that indicate a most appropriate focal distance range or corresponding focus state that fits most satisfying brightness quality on a digital image for naked eyes.

The flashlight intensity determination module 140 is configured to query a flash intensity lookup table using the focal distance, which may have been determined to be adjusted by the focal distance determination module 130 or may not. Note that the flash intensity lookup table is configured to store a plurality of focal distances as indexes and a plurality of flashlight intensities corresponding to each of the plurality of focal distances respectively, where the plurality of flashlight intensities are determined according to experimental and/or empirical results in advance. The flashlight intensity lookup table may be implemented inside the flashlight intensity determination module 140 using software, hardware, or firmware. The flashlight determination module may send a flashlight control signal (FCC) instructing flashlight intensity to be applied to the flashlight generator 114 of the image sensor module 110. The image sensor module 110 then adjusts the flash intensity applied to the flashlight generator 114 according to the flashlight control signal FCC.

In one embodiment of the present invention, the flashlight intensity is in proportional to the focal distance determined, i.e. the larger the focal distance is, the larger the flash intensity is. This is due to the amount of light received by objects at far distance would be comparatively weaker than the objects at near distance when applying same level of flashlight intensity. For example, if the focal distance belongs to a short distance range, i.e., an object captured by the lens unit 112 is located at a near position from the image capture system 100, the flashlight intensity corresponding to the near focal distance is set to a relatively small value. On the contrary, if the focal distance belongs to a longer focus range, i.e., the object is located at a far position from the image capture system 100, the flashlight intensity corresponding to the far focal distance is set to a relatively large value.

In one embodiment of the present invention, surrounding brightness condition of a scene captured in the image may also be regarded as an index for the flashlight intensity lookup table. The surrounding brightness condition may be obtained by determining luminance information of the image. The luminance information may be a representative luminance value of an image calculated by averaging luminance values of all pixels within the image by proper algorithm. The flashlight intensity is adjusted inversely proportional to the luminance value. A larger luminance value suggests that the scene is in brighter light condition, for example daylight or normal light, consequently the flashlight intensity may be set lower to avoid overexposure. A smaller luminance value may suggest the scene is taken in darker light condition, such as low light, as a result the flashlight intensity may be set higher so as to increase the brightness of the scene. In one embodiment of the present invention, the flashlight intensity lookup table may comprise correspondences of flashlight intensities and various luminance values with respect to different focal distances.

Yet in another embodiment of the present invention, a type of the scene corresponding to the surrounding brightness condition is determined by the flashlight intensity determination module 140. The image is classified into several scene types according to the luminance value and/or luminance distribution. The scene type may comprise normal, daylight, low light, night scene, backlight and/or other suitable type that can be identified by luminance value and/or distribution. The flashlight intensity determination module 140 may determine the flashlight intensity according to focal distance, luminance value and the scene type. Similarly, in this embodiment of the present invention, the flashlight intensity lookup table comprises correspondences of the flashlight intensity to various combination of focal distance, luminance value and scene type.

Still in another embodiment of the present invention, the flashlight intensity determination module 140 may increase or decrease a flashlight intensity determined by prior art method according to the focal distance, luminance value and/or scene type. For example, the image is to be taken by first flashlight intensity in conventional system. The first flashlight intensity is further adjusted to be increased by an amount determined according to the focal distance. As described above, the longer the focal distance is, the increasing amount is set larger. On the other hand, the first flashlight intensity is decreased by a predetermined amount in response to the focal distance is shorter. Similarly for the luminance value and scene type, different amount of flashlight intensity may be increased or decreased accordingly.

The user input module 150 is configured to receive inputs for capturing an image and/or setting focus to one or more objects in the scene. In one embodiment of the invention, an input is received by tapping on an object displayed in the scene and another input is received to capture an image with focus set to the object. The focus determination module 130 instructs the lens unit 112 to move to a position having best focus to the object according to the input, and the flashlight intensity determination module 140 determines the flashlight intensity to be applied according to the focal distance to the object. In another embodiment of the invention, a single input is used to set focus to an object and capture an image accordingly. The user input module 150 may be implemented as a touch screen which capable to receive touch input and display preview image of a scene. The use input module 150 may also be implemented by a touch screen for receiving input to set focus and a hardware shutter key for receiving input to capture the image. Furthermore, the user input module 150 maybe a Bluetooth control device or voice control device.

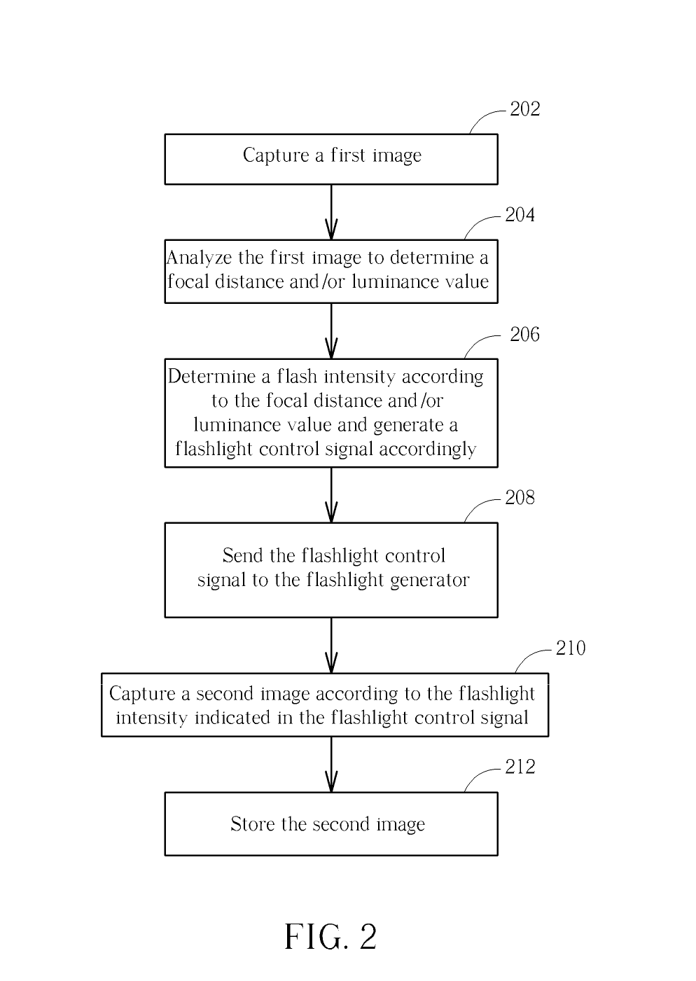

Please refer to FIG. 2, which illustrates an image capture method utilized by the image capture system 100 shown in FIG. 1 according to a first embodiment of the present invention. In the first embodiment, the flashlight intensity of the flashlight generator 114 is adjusted according to the focal distance. As shown in FIG. 2, the image capture method includes the following steps:

Step 202: Capture a first image I1.

Step 204: Analyze the first image I1 to determine a focal distance FD and/or luminance value corresponding to the first image I1.

Step 206: Determine a flash intensity according to the focal distance FD and/or luminance value and generate a flashlight control signal FCC accordingly. The flashlight intensity may be determined by using a flashlight intensity lookup table comprising correspondences of a plurality of focal distances and a plurality of focal distances and/or luminance values

Step 208: Send the flashlight control signal FCC to the flashlight generator 114 of the image sensor module 110.

Step 210: Capture a second image 12 according to the flashlight intensity indicated in the flashlight control signal DCC.

Step 212: Store the second image 12 in a memory unit of the image capture system 100.

In Step 202, the image sensor module 110 captures the first image I1. The first image may also be provided as a preview image displayed to the user.

In Step 204, the image analyzer 120 analyzes image characteristics on the first image I1 to estimate the focal distance FD, and transmits information of the focal distance FD to the flashlight intensity determination module 140. The image analyzer 120 may also determine the luminance value of the first image I1 and transmit the Luminance value to the flashlight intensity determination module 140. In one embodiment of the present invention, the image analyzer 120 analyzes the first image I1 in RAW image domain prior to converting into RGB format.

In Step 206, the flashlight intensity determination module 140 queries the flashlight intensity lookup table using the focal distance FD as an index to retrieve a flashlight intensity corresponding to current focal distance FD, where the flashlight intensity will be encapsulated in a flashlight control signal FCC. In the embodiment that luminance value is also determined, the luminance value is used as a second index of the flashlight intensity lookup table in which focal distance FD and the luminance value are cross referenced. Then the flashlight control signal FCC is transmitted from the flashlight intensity determination module 140 to the flashlight generator 114.

In Step 208, the flashlight control signal FCC is sent to the flashlight generator 114, and the flashlight generator 114 applies the flashlight intensity indicated by the flashlight control signal FCC. And In Step 210, the image sensor module 110 captures a second image 12 using the flashlight intensity currently applied on the flashlight generator 114. In Step 212, the captured second image 12 is encoded in suitable format, such as JPEG, and stored in a memory unit (not shown) of the image capture system 100. Please note that the second image 12 may be captured in response to an input for performing image capture from the user input module 150. Upon receiving the input, the first image I1 is analyzed to determine the proper flashlight intensity to be used for capturing the second image I2. As a result, the image capture device 100 is capable of presenting better brightness quality than the prior art with the aid of the flashlight intensity queried from the flashlight intensity lookup table.

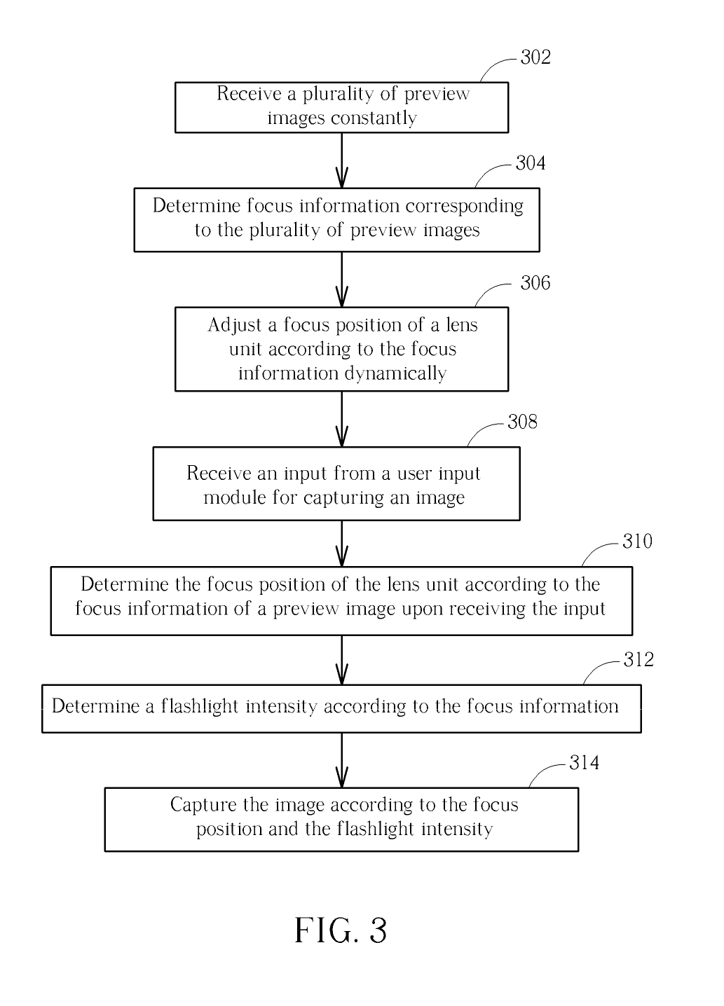

Please refer to FIG. 3, which illustrates the image capture method utilized by the image capture system 100 shown in FIG. 1 according to a second embodiment of the present invention. As shown in FIG. 3, the image capture method includes the following steps:

Step 302: Receive a plurality of preview images constantly.

Step 304: Determine focus information corresponding to the plurality of preview images.

Step 306: Adjust a focus position of the lens unit 112 according to the focus information dynamically.

Step 308: Receive an input from the user input module 150 for capturing an image.

Step 310: Determine the focus position of the lens unit 112 according to the focus information of a preview image upon receiving the input.

Step 312: Determine a flashlight intensity of the flash generator 114 according to the focus information.

Step 314: Capture the image according to the focus position and the flashlight intensity.

In Step 302, the image sensor module 110 constantly and dynamically receives a plurality of images and provides them as preview images displayed to the user.

In Step 304, the image analyzer 120 constantly receives the preview images and analyzes the preview images to obtain corresponding focus information. The focus information may be a focal distance and/or a focus state corresponding to the preview image. As described above, the image analyzer 129 may analyze the preview images in RAW image domain (before converting into RGB image domain), and may be implemented as a dedicated hardware processor or integrated with image signal processor, which comprises the focal distance determination module 130 and the flashlight intensity determination module 140.

In Step 306, the focal distance determination module 130 receives the focus information from the image analyzer 120 and determines whether to adjust the focus position of the lens unit 112 according to the focus information. For example, the focal distance determination module 130 may determine to adjust the focus position of the lens unit 112 by a predetermined step in a predetermined position in response to the focal distance and/or focus state satisfying a predetermined condition. Then the focal distance determination module 130 sends a focus control signal FOC to the lens unit 112 for adjusting the focus position. The process of Step 306 may be performed dynamically for each preview images so as to provide better viewing to the user. In this way, the image capture system may react to the changes of scenes without delay.

In Step 308, the input may be received via the user input module 150, such as a touch screen. For example, the user may tap on a shutter icon provided on the touch screen to capture an image, or the user may tap on an object displayed in the scene. In the latter case, the input is a command to set focus at the object and perform image capture. The user input module 150 may also be implemented in other mechanism, such as a hardware key, a Bluetooth control device or voice control device.

In Step 310, the image analyzer 120, same as in Step 304, analyzes the preview image in response to the input, and provides focus information to the focal distance determination module 130 and the flashlight intensity determination module 140. The focal distance determination module 130 sends a focus control signal FOC to the lens unit 112 for adjusting its focus position according to the focus information similarly to Step 306. In response to the input comprising an object to be focus, focal distance determination module 130 would adjust the focus position targeting the object correspondingly.

Then in Step 312, the flashlight intensity determination module 140 determines the flashlight intensity to be used for capturing the image according to the focus information. The focus information may comprise or suggest a focal distance with respect to the scene or object. The flashlight intensity determination module 140 can determine proper flashlight intensity by querying a flashlight intensity lookup table according to the focal distance. The flashlight intensity lookup table may comprise correspondences of flashlight intensity and focal distance. Generally speaking, the flashlight intensity is determined in proportional to the focal distance.

The flashlight intensity module 140 may also determine the flashlight intensity with reference to other parameters, such as luminance value and/or scene type corresponding to the preview image received upon receiving the input. The luminance value and the scene type provide light condition of the current scene and can be used to determine whether the flashlight intensity should be increased or decrease according to surrounding brightness. If the surrounding brightness is dark, the flashlight intensity can be increased to provide sufficient lighting for capturing the image. On the contrary, the flashlight intensity can be decreased in the condition that surrounding brightness is not too bad to avoid overexposure. As described, the luminance value can be calculated by arithmetic operations on pixels within the preview image, and the scene type can be classified by luminance value, luminance distribution and/or color characteristics.

In Step 314, the image sensor module 110 captures an image using the focal distance determined by the focal distance determination module 130 and the flashlight intensity determined by the flashlight intensity determination module 140. The focal distance and the flashlight intensity are determined according to the focus information derived by the image analyzer 120, which can be implemented as a dedicated hardware processor and thus provide better efficiency of processing.

Note that embodiments formed by reasonable combinations and/or permutations of the steps shown in FIGS. 2-3 and/or adding anyone of the abovementioned limitations to the steps shown in FIGS. 2-3 should also be regarded as embodiments of the present invention.

The present invention discloses an image capture method and an image capture system utilizing the image capture method. With the aid of the disclosed image capture method and the disclosed image capture system, better luminance performance for images captured by a lens can be fulfilled. As described in above embodiments of the present invention, the image capture device is benefit from using focus information and/or luminance information, which may reflect the surrounding condition of the scene to be taken, to adjust flashlight intensity. The focus information may suggest a distance relationship of the image capture device and the scene or object to be taken. Applying the same flash intensity to scenes/objects at different distances is not capable to achieve same satisfying mage quality. In the condition that the scene or object is at near distance, the flashlight intensity can be decreased since the amount of light received by near distance would be more than that received at far distance. Similarly, applying same flashlight intensity to different types of scene may result in some scene being too bright and some scene being too dark. Therefore, the present invention provides a novel method to solve above problems.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image capture method for use in an image capture system, comprising:
capturing a first image;
analyzing the first image to determine a focal distance corresponding to the first image;
determining a flashlight intensity according to the focal distance; and
capturing a second image according to the flashlight intensity.

2. The image capture method of claim 1, further comprising:
analyzing the first image to obtain a luminance value corresponding to the first image;
wherein the determining of the flashlight intensity further comprises determining the flashlight intensity according to the focal distance and the luminance value.

3. The image capture method of claim 2, wherein the flashlight intensity is increased reversely proportional to the luminance value with respect to the same focal distance.

4. The image capture method of claim 1, wherein the flashlight intensity is determined according to a lookup table comprising correspondence of a plurality of focal distances and a plurality of flashlight intensities respectively.

5. The image capture method of claim 4, wherein the flashlight intensity is increased proportional to the focal distance.

6. The image capture method of claim 1, wherein the first image is analyzed in RAW image domain by a dedicated processing unit to obtain the focal distance.

7. The image capture method of claim 1, further comprises. receiving an user input from a user input module of the image capture device; and
storing the second image in a memory unit of the image capture device.

8. An image capture method for use in an image capture system comprising a lens module and a flashlight generator for capturing images, comprising:
receiving a plurality of preview images constantly;
determining focus information corresponding to the plurality of preview images;
adjusting a focus position of the lens module according to the focus information dynamically;
receiving an input for capturing an image;
determining the focus position of the lens module according to the focus information of a preview image received upon receiving the input;
determining a flash intensity of the flash generator according to the focus information; and
capturing the image according to the focus position and the flash intensity.

9. The method of claim 8, further comprising:
determining luminance information and scene information corresponding to the preview image received upon receiving the input, the luminance information indicating a luminance value of the preview image and the scene information indicating a type of scene corresponding to the preview image ;
wherein the determining of the flash intensity further comprises determining the flash intensity according to the focus information, the luminance information and the scene information.

10. The method of claim 8, wherein the type of scene comprises a combination of at least the following: normal, daylight, backlight, and low light.

11. The method of claim 8, wherein the focus information comprises a focus distance, and the determining of the flash intensity further comprises determining the flash intensity by a lookup table comprising correspondence of a plurality of focus distances and a plurality of flash intensities respectively.

12. The method of claim 8, wherein the determining of the focus information further comprises analyzing the plurality of preview images in RAW image domain by a dedicated processing module, and the focus information comprises the focus distance and a focus state.

13. The method of claim 12, wherein the adjusting of the focus position further comprises adjusting the focus position of the lens module according to the focus state.

14. The method of claim 8, wherein the input further comprises an indication of an object to be focused, and the flash intensity is determined according to the focus information with respect to the object.

15. An image capture system, comprising:
an image sensor module, comprising a lens unit and a flash generator and configured to capture at least a first image and a second image;
an image analyzer, configured to receive the first image from the image sensor module and analyze the first image to obtain focus information corresponding to the first image; and
a flash intensity determination module, configured to determine a flash intensity of the flash generator according to the focus information;
wherein the second image is captured according to the flash intensity.

16. The image capture system of claim 15, wherein the image analyzer is further configured to receive and analyze the first image in RAW image domain and the focus information comprises at least a focus distance and a focus state; and wherein the flash intensity determination module is further configured to determine the flash intensity according to the focus distance.

17. The image capture system of claim 16, wherein the flash intensity determination module is further configured to determine the flash intensity according to a lookup table comprising correspondence of a plurality of focus distances and a plurality of flash intensities respectively.

18. The image capture system of claim 16, further comprises:
a focal distance determination module, configured to determine a focus position of the lens unit according to the focus state; wherein the second image is captured according to the focus position and the flash intensity.

19. The image capture system, of claim 15, wherein the flash intensity determination module is further configured to determine luminance information and scene type information corresponding to the first image, and the flash intensity is determined according to the luminance information and the scene type information.

20. The image capture system of claim 15, further comprises:
a user interface module configured to receive an input for capturing the second image, the input comprising an indication of an object to be focused;
wherein the flash intensity is determined according to the focus information with respect to the object.
